(19) United States
(12) Patent Application Publication
(10) Pub. No.: US 2026/0291913 A1
(43) Pub. Date: Sep. 24, 2026

(54) CONTEXT-AWARE WEBSOCKET COMMUNICATION

(71) Applicant: SAP SE, Walldorf (DE)

(72) Inventor: Oliver Klemenz, Sinsheim (DE)

(73) Assignee: SAP SE, Walldorf (DE)

(21) Appl. No.: 19/085,271

(22) Filed: Mar. 20, 2025

(51) Int. Cl. H04L 9/40; H04L 67/63

(52) U.S. Cl. CPC H04L 63/0236; H04L 67/63

(57) ABSTRACT

A computer-implemented method includes receiving an event published by an application running on a server in response to a request for a service; filtering a full list of users of the server, using a tenant filter, to identify a group of tenant users who belong to a tenant identified by the event; filtering the group of tenant users, using a service filter, to identify a group of service-specific users interacting with the service identified by the event; filtering the group of service-specific users, using one or more user filters, to identify a group of eligible users permitted to receive the event; filtering the group of eligible users, using one or more topic filters, to identify a group of target users who subscribe to a topic of the event; and routing the event, via WebSocket connections, to a group of target clients associated with the group of target users.

### BACKGROUND

WebSocket technology enables real-time, bidirectional communication between clients and servers, providing an efficient alternative to traditional HTTP-based request-response mechanisms. By establishing a persistent connection, WebSockets can significantly reduce latency and network overhead, making them ideal for applications that require instant data updates, such as live notifications, financial transactions, and collaborative platforms. Despite its advantages, conventional WebSocket communication remains a purely technical protocol, lacking mechanisms to apply business context to data transmission. In multi-tenant enterprise environments, different users, services, and applications interact with various events that require tailored dissemination based on business rules, user roles, subscription topics, etc. Without an integrated approach to incorporating business semantics, WebSocket communication remains generic and unstructured, limiting its ability to support complex enterprise workflows effectively. Thus, there is room for improvement in enhancing WebSocket communication with business semantics to enable context-aware, secure, and efficient message routing in multi-tenant enterprise environments..

### BRIEF DESCRIPTION OF THE DRAWINGS

FIG. 1 is an overall block diagram of an example multitenant computing system supporting context-aware WebSocket communication.

FIG. 2 is a schematic diagram depicting a structured model for client determination in the context of a multi-tenant, service-oriented computing environment.

FIG. 3 is a flowchart illustrating an example overall method of implementing context-aware WebSocket communication.

FIG. 4 is a flow diagram illustrating an example filtering process for context-aware WebSocket communication.

FIG. 5 lists an example high-level source code for tenant-level and service-level filtering for context-aware WebSocket communication.

FIG. 6 lists an example high-level source code for user-level, topic-level, and client-level filtering for context-aware WebSocket communication.

FIG. 7 lists example user filters specifying inclusion or exclusion of current user.

FIG. 8 lists example user filters specifying inclusion or exclusion of defined users.

FIG. 9 lists example topic filters specifying inclusion or exclusion of topics.

FIG. 10 lists example client filters specifying inclusion or exclusion of clients.

FIG. 11 is a block diagram of an example computing system in which described embodiments can be implemented.

FIG. 12 is a block diagram of an example cloud computing environment that can be used in conjunction with the technologies described herein.

### DETAILED DESCRIPTION

### Overview of WebSocket Communication

WebSocket is a communication protocol that enables full-duplex, bidirectional data exchange between a client and a server over a single, long-lived connection. Standardized as RFC 6455 by the Internet Engineering Task Force (IETF), WebSocket is designed to overcome the limitations of traditional HTTP-based communication, which relies on a request-response model. Unlike HTTP, where the client must repeatedly send requests to retrieve updates, WebSocket establishes a persistent connection that allows both the client and server to send messages at any time without additional handshakes, reducing latency and improving data transmission efficiency.

The implementation of WebSocket begins with an initial handshake over HTTP, where the client and server agree to upgrade their connection to WebSocket. Once established, this connection remains open, enabling real-time data exchange with minimal overhead. WebSocket communication is commonly implemented in web browsers, mobile applications, and enterprise systems, supporting various use cases such as live messaging, collaborative editing, financial market feeds, multiplayer gaming, and real-time monitoring. WebSocket messages can be transmitted in either text or binary format, making the protocol suitable for a wide range of data structures and applications.

One of the primary advantages of WebSocket is its efficiency in handling real-time data at scale. By eliminating the need for repeated HTTP requests, WebSocket can significantly reduce network congestion and server load. This makes it particularly beneficial for applications that require frequent updates, such as stock trading platforms, IoT device communication, and cloud-based enterprise solutions.

Despite its benefits, WebSocket communication presents several technical challenges, particularly in its lack of built-in semantic or contextual awareness. WebSocket operates as a low-level communication protocol that simply transmits raw data between clients and servers without any understanding of the meaning, relevance, or intended recipients of that data. Unlike application-layer protocols that incorporate structured messaging formats and business rules, WebSocket does not inherently distinguish between different types of messages, users, or services. This absence of contextual awareness makes it difficult to ensure that real-time messages are delivered only to relevant recipients based on their role, permissions, or ongoing interactions. Furthermore, in multi-tenant environments where multiple organizations share computing resources, WebSocket lacks native support for tenant isolation, potentially leading to unintended data exposure or inefficient message dissemination. Without an integrated mechanism to apply business semantics, WebSocket communication remains generic, requiring extensive customization to be practically utilized in complex enterprise workflows.

The technologies described herein address many of the challenges described above by incorporating contextual intelligence into WebSocket communication, enabling context-aware data transmission based on user roles, service interactions, and tenant-specific constraints. Such context-aware WebSocket communication technologies can be applied across a wide variety of enterprise software environments.

### Example Computing System Supporting Context-Aware WebSocket Communication

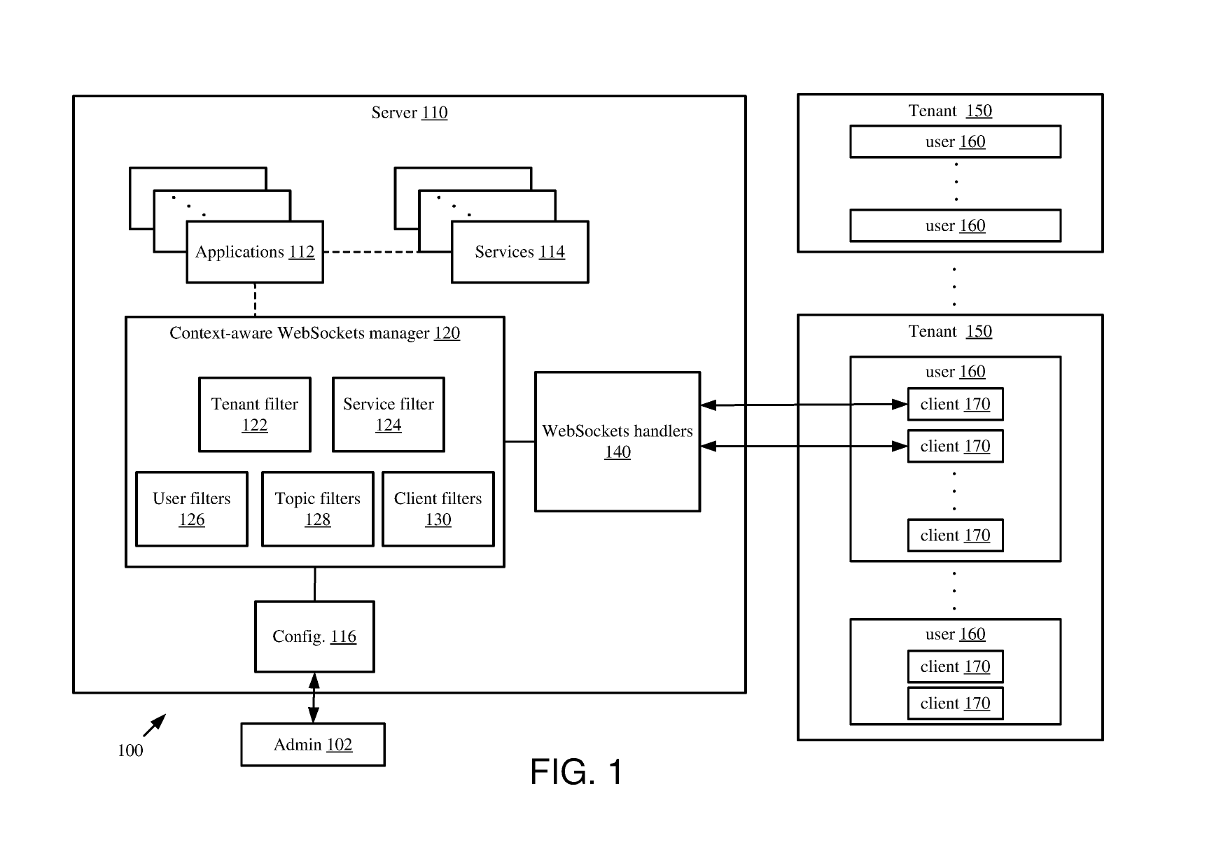

FIG. 1 shows an overall block diagram of an computing system 100 supporting context-aware WebSocket communication between a server and selected clients in a multi-tenant computing environment.

The computing system 100 includes a server 110, which can host a number of applications 112 and provides a variety of services 114. The server 110 can be configured to support multiple tenants 150, each of which can have multiple users 160 with different roles. In some examples, users may be grouped, e.g., based on their roles and/or organizational structures (e.g., teams, departments, etc.). In some examples, each user 160 can be associated with one or more clients 170, which can include computing devices (e.g., desktop computers, laptops, tablets, smartphones, etc.) running client-side applications that interact with the server 110 over a network.

In a multi-tenant architecture, multiple organizations (e.g., tenants 150) can share the same computing infrastructure while maintaining logical separation of data and operations. A user 160 from one tenant 150 can log in to the server 110 after authentication and authorization. Upon logging in, the user 160 may run an application 112 hosted on the server 110 and request a service 114. In some examples, the server 110 can employ a microservices architecture, where different services 114 function as independent units handling specific business processes. For example, different services 114 may be responsible for different tasks, such as processing sales orders, managing financial records, handling notifications, etc. Microservices enable modularity, scalability, and independent deployment of different functionalities within the system.

In response to a request for a service 114 made by a user 160 through an application 112, the application 112 can invoke the corresponding service 114 and generate an event, which can also be referred to as an event object. The event may be published asynchronously, meaning that there may be a delay between the user request and the event generation, depending on the processing time of the service 114. For example, in a database query scenario, an event containing query results may be generated with a relatively short delay after the request, depending on data retrieval speed and query complexity. In contrast, in a financial closing system, an event indicating the completion of a month-end reconciliation process may be published with a relatively longer delay, as it may depend on multiple approvals and sequential processing steps. As described herein, the event can be posted in an event-driven (trigger) mode, notifying relevant target users to receive the event when it becomes available.

The event may include metadata containing environment information about the application and the corresponding service. For example, the metadata may identify the tenant 150 associated with the request, the user 160 who initiated the request, and the specific service 114 involved. Additionally, the event contains a payload representing the results of running the service, which is returned from the application 112 to target users. The payload may carry relevant data in response to the user request, such as order details in a purchase order system, task completion status in a financial closing system, or the like. In some examples, the payload of the event can be analyzed to dynamically determine—for example, at runtime when the application 112 generates the event—specific clients, specific users, and/or specific topics, to be included or excluded from WebSocket communication.

The event can be communicated to various target users, which may include the requesting user and/or other users with relevant roles or interests in the event outcome. For example, in a purchase order scenario, the procurement manager and finance team may be target users who need to review or approve the transaction. In a financial closing scenario, accountants and auditors may require real-time updates on the status of closing activities to monitor progress, resolve discrepancies, or validate final reports.

As shown, the server 110 includes a context-aware WebSockets manager 120, which is configured to facilitate efficient event communication by determining the appropriate target users and, if necessary, their respective target clients. Specifically, the context-aware WebSockets manager 120 can apply a series of filters to identify the correct recipients of the event. In some examples, the context-aware WebSockets manager 120 includes a tenant filter 122, a service filter 124, one or more user filters 126, one or more topic filters 128 (also referred to as context filters), and one or more client filters 130. These filters can be configured to ensure that only relevant users and devices receive the event through dedicated WebSocket communication, as described more fully below.

In some examples, at least some of filters can be defined and maintained by an administrator 102, who configures them in a configuration file 116 or the like. The configuration file 116 can be structured in different formats, such as JSON, YAML, or other configuration languages, allowing flexibility in defining filtering rules. In one specific example, the configuration file 116 can be written using Core Data Services (CDS) annotations, as commonly used in SAP software environments, to specify filtering criteria in a declarative manner. The configuration file 116 provides specifications for how events should be processed and routed, including which users or clients should be included or excluded from receiving specific types of events. The filtering process can follow a pipeline approach, where the filter are applied in sequence to progressively refine the list of recipients.

Once the target users and target clients 170 are identified, the event can be transmitted to the target clients via WebSockets. As shown, the server 110 can include a WebSockets handler 140 configured to facilitate WebSocket communication between the server 110 and target clients. In some examples, the WebSockets handler 140 can include a library that manages WebSocket connections, handling operations such as connection establishment, maintenance, and termination. The library can be implemented in various programming languages, such as JavaScript (Node.js), Phyton, Java, etc.

The combination of context-aware WebSockets manager 120 and WebSockets handler 140 enhances WebSocket communication by incorporating business semantics, ensuring that events are delivered only to users who are authorized and have a relevant interest in the event’s outcome. For example, an event published by a financial closing service may only be relevant to accountants responsible for reconciliation tasks, whereas a notification from a sales order service may be relevant to procurement officers and finance teams. Metadata associated with the event, such as the tenant, user, and service, allows the context-aware WebSockets manager 120 to apply business semantics to dynamically determine the appropriate target users (and target clients).

As described further below, context-aware WebSocket communication can be achieved through various filters designed for tenant isolation, service isolation, topic-specific (or context-specific) distribution, user-specific filtering, and client-specific targeting. Tenant isolation (e.g., through the tenant filter 122) ensures that events are only delivered to users within the appropriate tenant, preventing cross-tenant data exposure. Service isolation (e.g., through the service filter 124) ensures that events are scoped to the appropriate service, so target users receive only relevant updates. Topic-specific distribution (e.g., through the topic filters 128) refines event delivery based on context of the payload, ensuring that only target users subscribed to specific topics or contexts receive relevant updates. User filtering (e.g., through the user filters 126) enables inclusion or exclusion of specific users based on predefined criteria, refining event delivery to those explicitly designated as recipients. Client filtering (e.g., through the client filters 130) ensures that events are routed to the appropriate target clients, allowing granular control over which user devices receive WebSocket updates.

Thus, the computing system 100 implements an intelligent WebSocket communication framework that optimizes real-time event dissemination in a multi-tenant environment. By leveraging contextual event data and a structured filtering mechanism, the computing system 100 ensures that WebSocket communication is efficient, secure, and relevant to the intended recipients.

In practice, the systems shown herein, such as system 100, can vary in complexity, with additional functionality, more complex components, and the like. For example, there can be additional functionality within the server 110. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the event, various filters, configuration file, and the like can be stored in one or more computer-readable storage media or computer-readable storage devices. The technologies described herein can be generic to the specifics of operating systems or hardware and can be applied in any variety of environments to take advantage of the described features.

### Example Client Determination

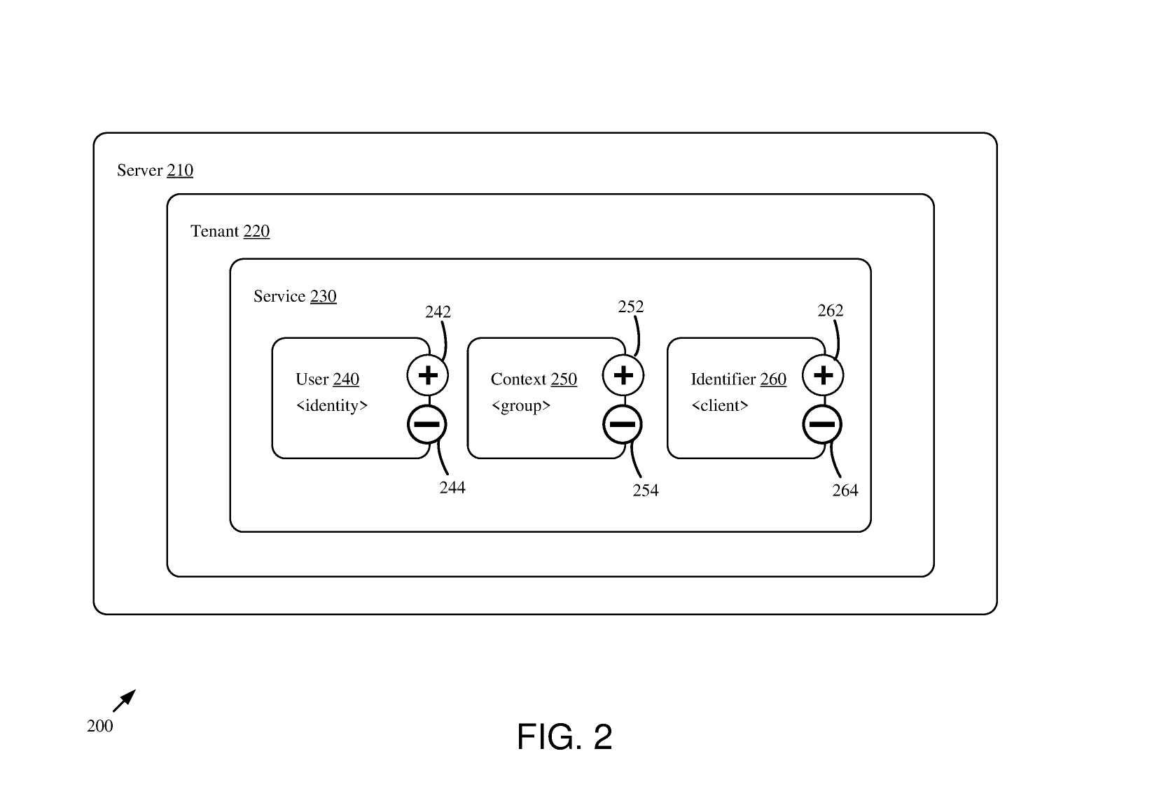

FIG. 2 illustrates an example structured model 200 for client determination in a multi-tenant computing environment, incorporating tenant isolation, service segmentation, user authentication, event handling, and client identification to enable context-aware WebSocket communication.

The outermost layer of the model 200 represents a server 210, which provides the underlying infrastructure to support multi-tenant operations, hosting multiple tenants while enforcing security, scalability, and resource management. The tenant layer 220 represents tenant isolation, allowing each tenant to operate in a logically separated environment to prevent data leakage and unauthorized access across different organizations. Within each tenant, the service layer 230 manages independent services, each responsible for specific functionalities so that event processing and WebSocket communication remain service-specific and segregated.

Within the service layer 230, there can be a user layer 240, a context layer 250, and a client layer 260. The user layer 240 can apply authentication and authorization to determine whether an event should be delivered to a given user, while the context layer 250 can further refine event distribution based on group associations or business relevance. For example, multiple users can be grouped into a user group (e.g., all members of a finance team) to receive notifications related to financial approvals. As another example, events can be grouped based on a specific topic (e.g., “purchase order updates”) to which users may subscribe, allowing them to receive only the notifications relevant to their role or interests. The client layer 260 can route WebSocket events to the appropriate client devices, allowing for precise delivery based on active sessions, device type, or user preferences.

Each layer in the model 200 can be associated with filters that refine WebSocket event distribution. For example, the tenant layer 220 can include a tenant filter (e.g., 122), which enforces tenant isolation by restricting events to users within the corresponding tenant and preventing cross-tenant data exposure. The service layer 230 can include a service filter (e.g., 124), which maintains service-specific segregation and prevents unnecessary notifications across different services.

The user layer 240 can apply user filters (e.g., 126), enabling inclusion 242 or exclusion 244 of specific users based on predefined criteria. For example, a user filter can explicitly include certain users (e.g., a finance manager who must approve purchase orders), or exclude others (e.g., an employee who does not require access to financial notifications). The context layer 250 can apply topic filters (e.g., 128), allowing events to be included 252 for users subscribed to specific topics (e.g., “purchase order updates”) or excluded 254 for topics that are not relevant (e.g., “marketing updates”). The client layer 260 can apply client filters (e.g., 130), ensuring that WebSocket updates are included 262 for approved devices (e.g., a user’s tablet) and excluded 264 from unauthorized devices (e.g., a public desktop terminal).

### Example Overall Method for Context-Aware WebSocket Communication

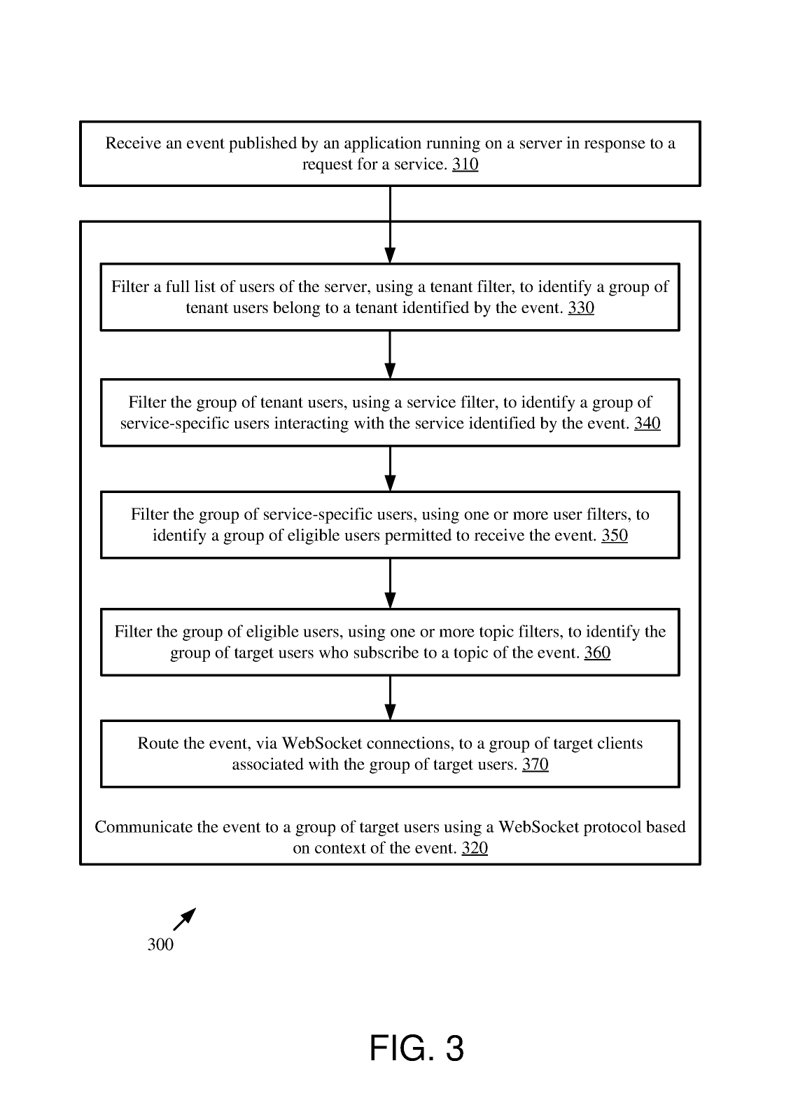

FIG. 3 is a flowchart of an example overall method 300 for context-aware WebSocket communication. The method 300 can be performed, for example, by the computing system 100 of FIG. 1.

At step 310, the method can receive an event published by an application running on a server in response to a request for a service. The server hosts multiple tenants in a multi-tenant computing environment.

At step 320, the method can communicate the event to a group of target users using a WebSocket protocol based on context of the event. Communicating the event to the group of target users can have the following sub-steps.

At step 330, the method can filter a full list of users of the server, using a tenant filter, to identify a group of tenant users. The group of tenant users belong to a tenant identified by the event.

At step 340, the method can filter the group of tenant users, using a service filter, to identify a group of service-specific users interacting with the service identified by the event.

At step 350, the method can filter the group of service-specific users, using one or more user filters, to identify a group of eligible users permitted to receive the event.

At step 360, the method can filter the group of eligible users, using one or more topic filters, to identify the group of target users who subscribe to a topic of the event.

Then, at step 370, the method can route the event, via WebSocket connections, to a group of target clients associated with the group of target users.

In some examples, the step 320 can further include filtering a full list of clients associated with the group of target users, using one or more client filters, to identify the group of target clients receiving the event via the WebSocket connections. At least one target user is associated with a plurality of clients. The one or more client filters are configured to identify which clients, if any, among the plurality of clients, are target clients for receiving the event.

In some examples, the step 320 can further include defining the one or more client filters in a configuration file. The one or more client filters specify inclusion or exclusion of specific clients, among the full list of clients, to determine the group of target clients.

In some examples, the specific clients are determined from a payload of the event when the application generates the event at runtime.

In some examples, the method can further include defining the one or more user filters and the one or more topic filters in a configuration file.

In some examples, defining the one or more user filters includes specifying inclusion or exclusion of specific users, among the group of service-specific users, to determine eligible users.

In some examples, the specific users include a current user who initiated the request for the service and one or more predefined users other than the current user.

In some examples, the specific users are determined from a payload of the event when the application generates the event at runtime.

In some examples, defining the one or more topic filters includes specifying inclusion or exclusion of specific topics, among a plurality of topics, to determine whether an eligible user subscribed to the topic of the event is identified as a target user. Inclusion of the topic in the topic filters results in the eligible user being a target user, and exclusion of the topic in the topic filters results in the eligible user not being a target user.

In some examples, the specific topics are determined from a payload of the event when the application generates the event at runtime.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example Filtering Process for Context-Aware WebSocket Communication

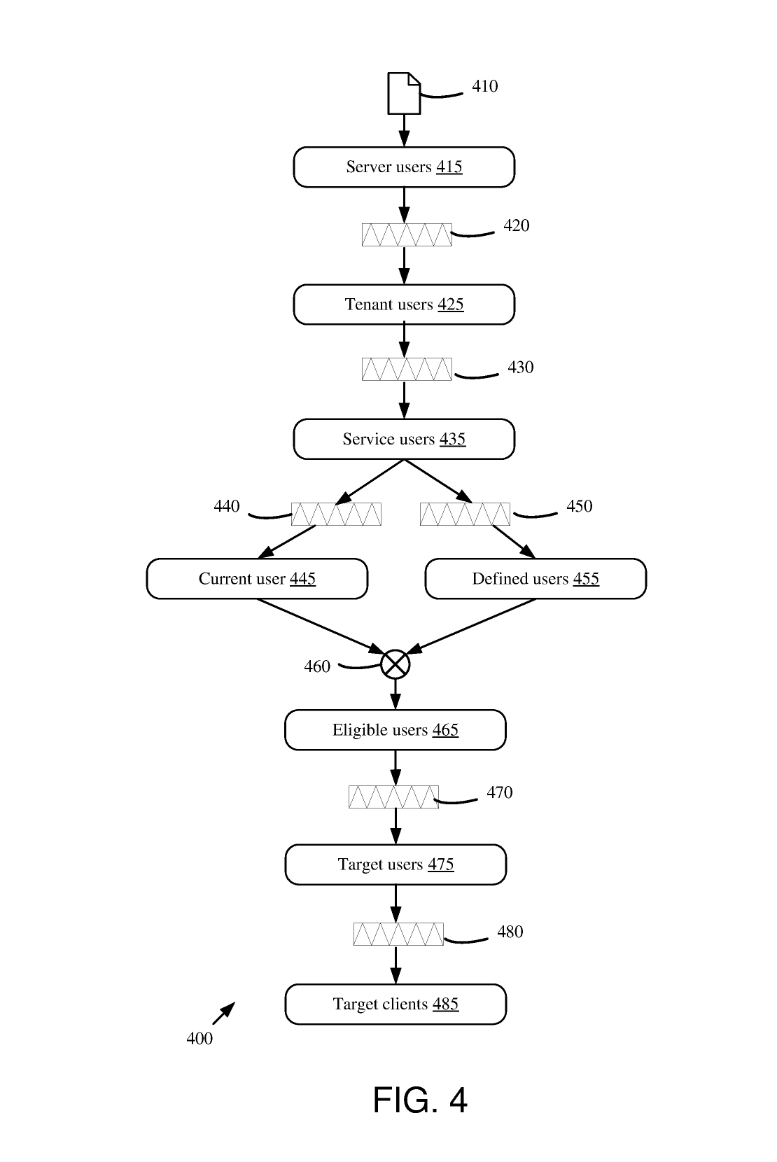

FIG. 4 illustrates an example filtering process 400 for context-aware WebSocket communication. The process 400 begins when an event 410 is generated in response to a user request for a service within a multi-tenant system. This event 410 must be distributed efficiently to appropriate users while maintaining tenant isolation, service-specific filtering, and context-driven user selection.

The filtering process 400 starts by identifying the server-wide users from a global user pool 415. The first filter applied is a tenant filter 420 (similar to the tenant filter 122), which isolates users belonging to the relevant tenant associated with the event, ensuring that no cross-tenant data leakage occurs. This results in a refined set of tenant users 425. Next, a service filter 430 (similar to the service filter 124) is applied to further narrow down the recipients to only those interacting with the specific service that generated the event 410, producing a subset of service users 435. This service-level segmentation ensures that users unrelated to a particular service do not receive unnecessary notifications.

The next phase of filtering process 400 involves determining which users within the service context should receive the event. At this stage, two types of filters are involved: current user filters 440 and defined user filters 450 (collectively similar to the user filters 126). The current user filter 440 determines whether the current user 445 who initiated the request should receive the event 410, while the defined user filter 450 determines if additional predefined users 455, such as approvers, supervisors, or team members involved in the workflow, should also receive the event 410. These two filtered user sets are then combined through an aggregation process 460, which consolidates them into a refined list of eligible users 465.

Once the eligible users 465 have been identified, the filtering process 400 can apply additional refinement through one or more topic filters 470 (similar to the topic filters 128). This ensures that event distribution is further categorized based on relevant topics or contextual subscriptions. For example, if an event 410 pertains to purchase order approvals, only users subscribed to that topic will remain in the distribution list, while others who are not subscribed will be excluded. The output of this filtering step is a refined list of target users 475, representing the final set of recipients authorized to receive the event 410.

After determining the target users 475, the final step in the filtering process 400 involves selecting appropriate client devices for event delivery via WebSocket connections. One or more client filters 480 (similar to the client filters 130) can be applied to identify the target clients 485 associated with the target users 475. Since a target user may be logged in from multiple devices (e.g., desktop, smartphone, tablet, etc.), the system can selectively route the event 410, via WebSocket connections, to the authorized and active devices, while excluding unauthorized or inactive devices. This client-level filtering enhances security by ensuring that sensitive information is only delivered to appropriate endpoints (target clients 485), while also optimizing network efficiency by reducing unnecessary WebSocket transmissions.

### Example Software Implementation of Context-Aware WebSocket Communication

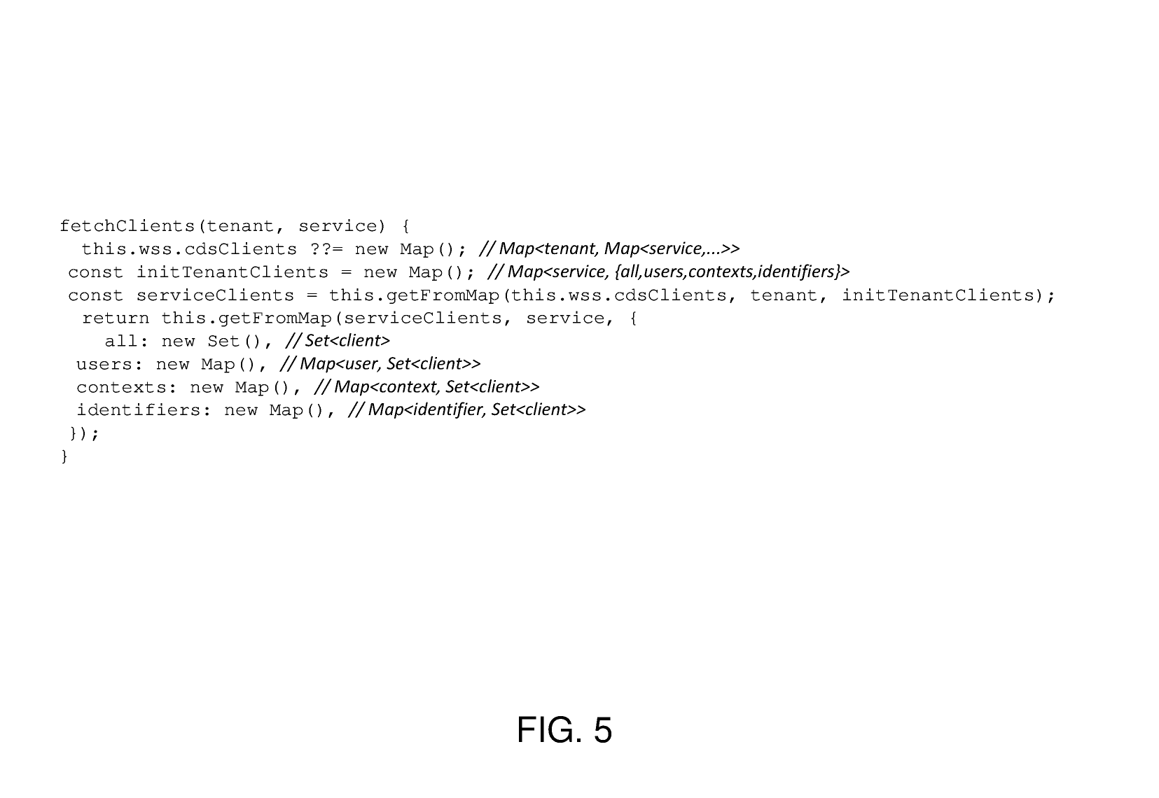

FIG. 5 illustrates an example high-level source code implementation for tenant-level and service-level filtering in a context-aware WebSocket communication system. In this example, the function fetchClients(tenant, service) retrieves WebSocket-connected clients based on the specified tenant and service. The function initializes a map-based data structure, where this.wss.cdsClients stores tenant-specific service client mappings so that client connections are logically separated per tenant. Within each tenant-level mapping, a service-level mapping is maintained, containing multiple sub-maps that categorize clients by user identity, context (e.g., topics), and client identifiers. The function checks for an existing service-specific client mapping within a given tenant, and if none exists, it initializes a new structure. The function returns a serviceClients object that contains categorized client sets, ensuring that WebSocket communication remains tenant-isolated and service-segregated.

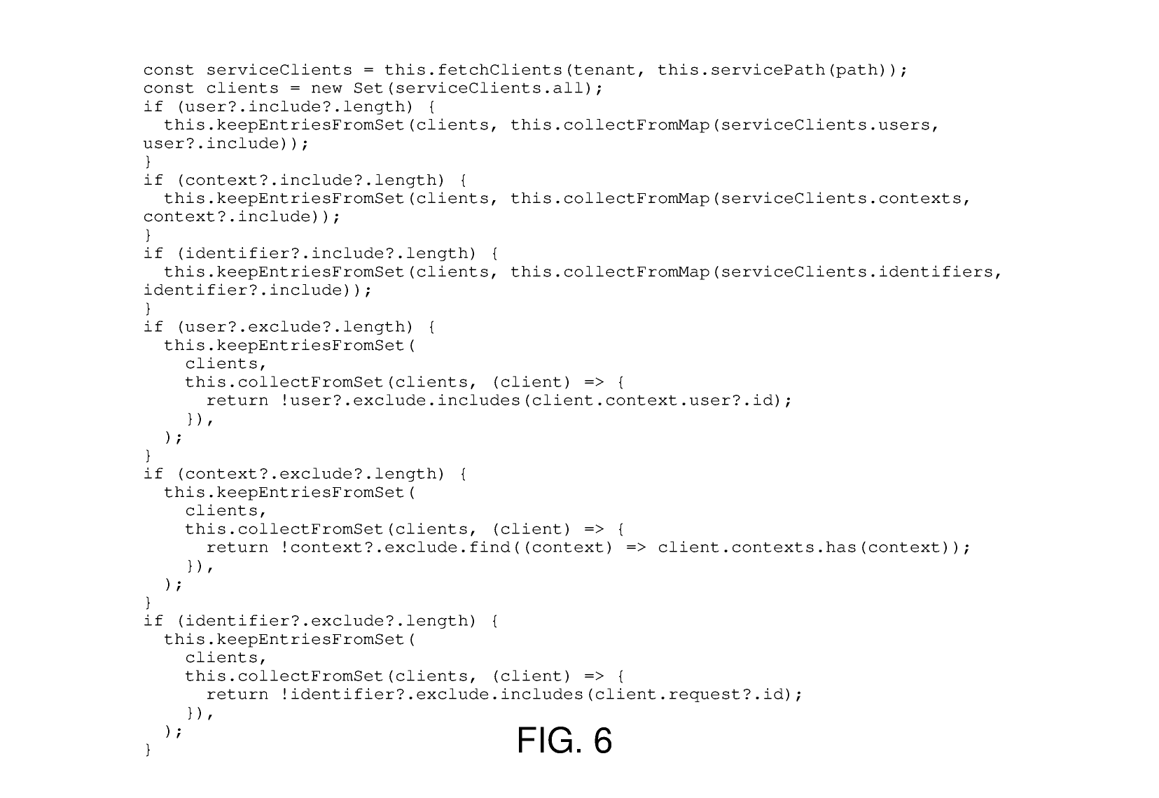

FIG. 6 shows an example high-level source code implementation for user-level, topic-level, and client-level filtering in a context-aware WebSocket communication system. In this example, the filtering process refines the list of WebSocket-connected clients retrieved from fetchClients(tenant, service) by applying inclusion and exclusion rules at multiple levels. The function first applies user-based filtering, checking if specific users are explicitly included (user?.include) or excluded (user?.exclude). If an inclusion list is present, only clients associated with the specified users are retained. If an exclusion list is provided, clients matching those users are removed. Next, the function applies topic-based filtering, evaluating whether clients are subscribed to relevant contexts (context?.include) or should be excluded from specific topics (context?.exclude). Clients are retained if they belong to an allowed context group and removed if explicitly excluded. Finally, client-level filtering is applied based on device identifiers (identifier?.include and identifier?.exclude). This ensures that WebSocket events are delivered only to authorized clients, while excluding unauthorized clients. In the depicted example, the filtering logic uses a keepEntriesFromSet function to modify the client set dynamically.

### Example Filter Annotations

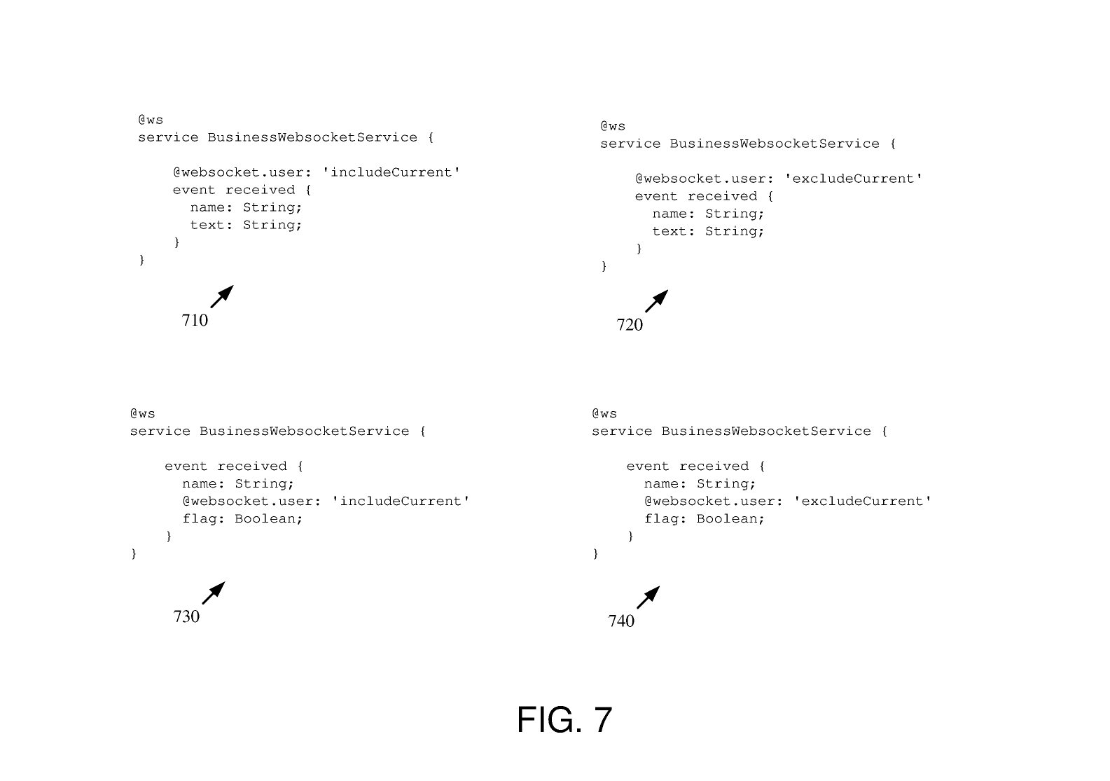

FIGS. 7-10 illustrate example filter annotations that can be used in context-aware WebSocket communication, defining inclusion and exclusion rules for users, topics (contexts), and clients. These filter annotations can be included in a configuration file (e.g., 116), which can be edited by an administrator (e.g., 102). The depicted examples utilize SAP Core Data Model (CDS) definitions, but it should be understood that similar annotations can be specified in other data formats, such as JSON, YAML, or the like.

The annotated filters can be categorized into static filters, which explicitly define inclusion/exclusion rules using fixed values, and dynamic filters, which determine filter values based on event data at runtime. Specifically, the inclusion or exclusion criteria in dynamic filters can be extracted from the payload of the event when the application generates the event. For example, a dynamic user filter may determine recipients based on a list of approvers included in the event payload, a dynamic topic filter may extract the event category or topic from metadata embedded in the payload, and a dynamic client filter may use the requesting device identifier embedded in the payload to decide whether the event should be routed to that specific client.

FIG. 7 demonstrates example current user filters, which specify whether the user who initiated the request should receive the event. For instance, annotation 710 applies a static inclusion filter to always include the current user, while annotation 720 applies a static exclusion filter to remove the current user from the event recipients. Annotations 730 and 740 extend this logic using dynamic filters, where the inclusion/exclusion of the current user is determined by a Boolean flag specified at runtime.

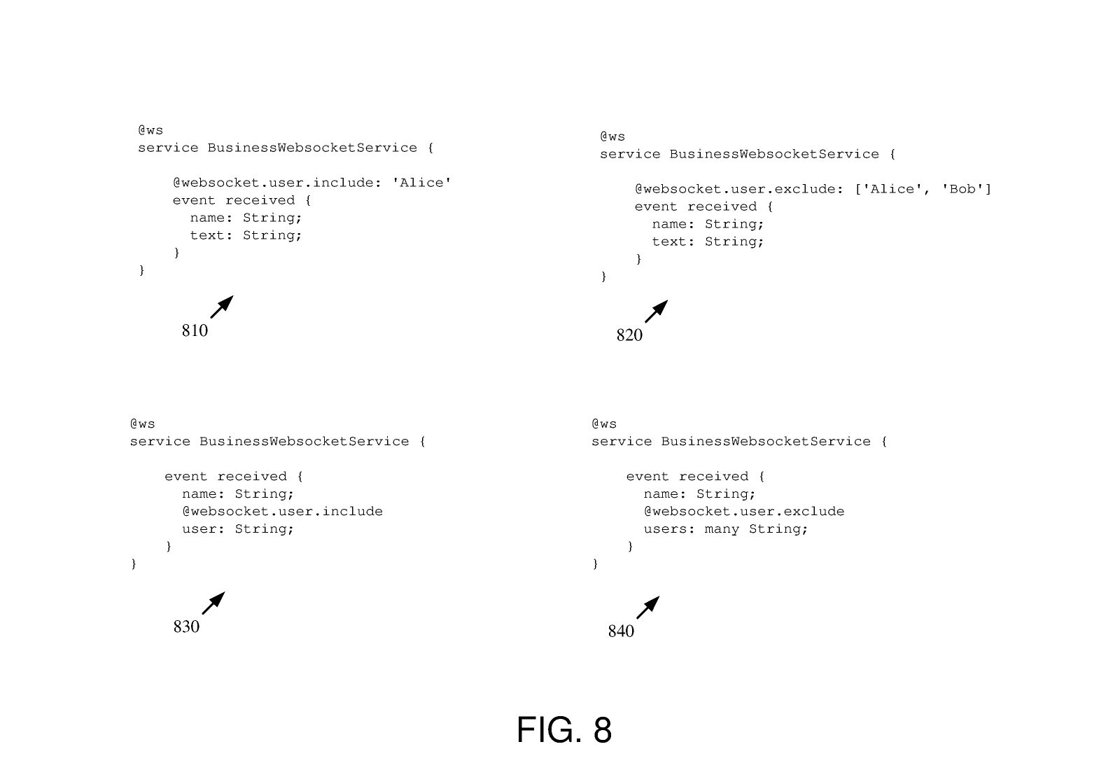

FIG. 8 expands user filtering by defining explicit user inclusion and exclusion rules. For example, annotation 810 specifies a static filter to include a predefined user (‘Alice’), while annotation 820 excludes multiple users ([‘Alice’, ‘Bob’]). The dynamic filters in annotations 830 and 840 determine user inclusion/exclusion based on user identifiers provided at runtime (e.g., fetching a user identifier dynamically from the event payload). These filters can refine event delivery based on user roles and access policies.

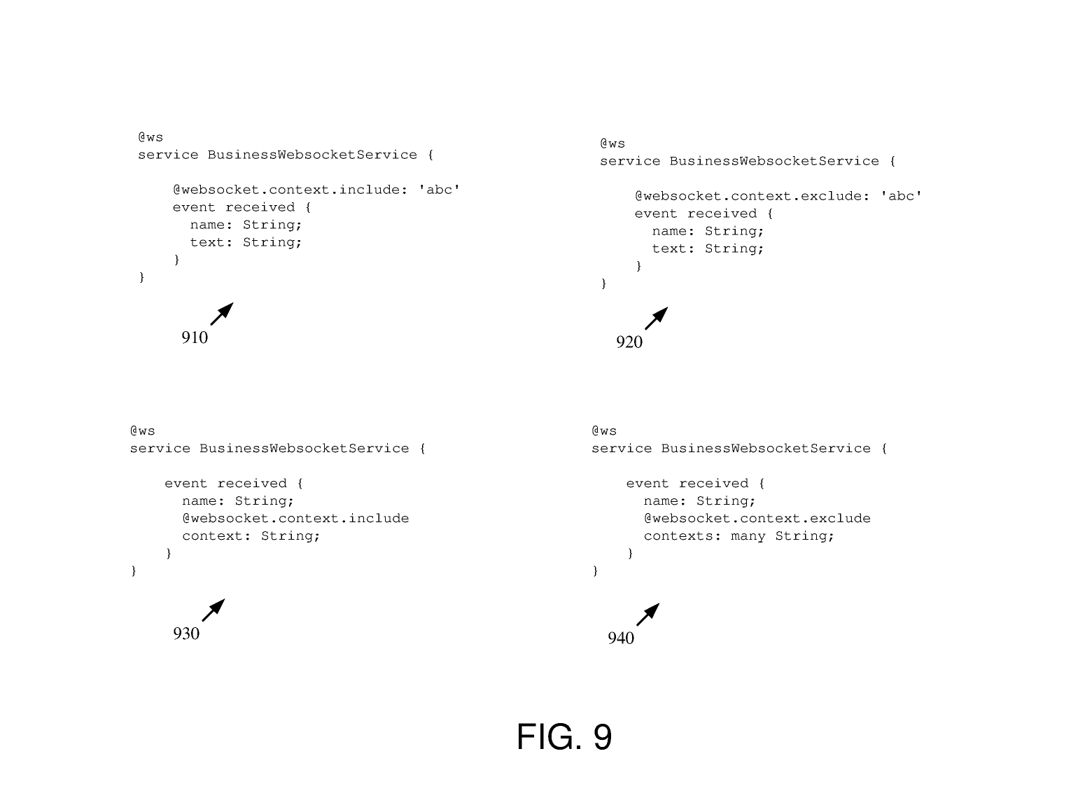

FIG. 9 illustrates topic-based filtering, also referred to as context filtering. These filters can categorize events into topics, allowing users to subscribe to or opt out of certain event categories. In the depicted example, annotation 910 defines a static filter to include only users subscribed to the topic ‘abc’, while annotation 920 excludes users subscribed to the same topic. Annotations 930 and 940 demonstrate dynamic filtering, where context inclusion/exclusion is determined by a runtime-specified topic string or a list of topics.

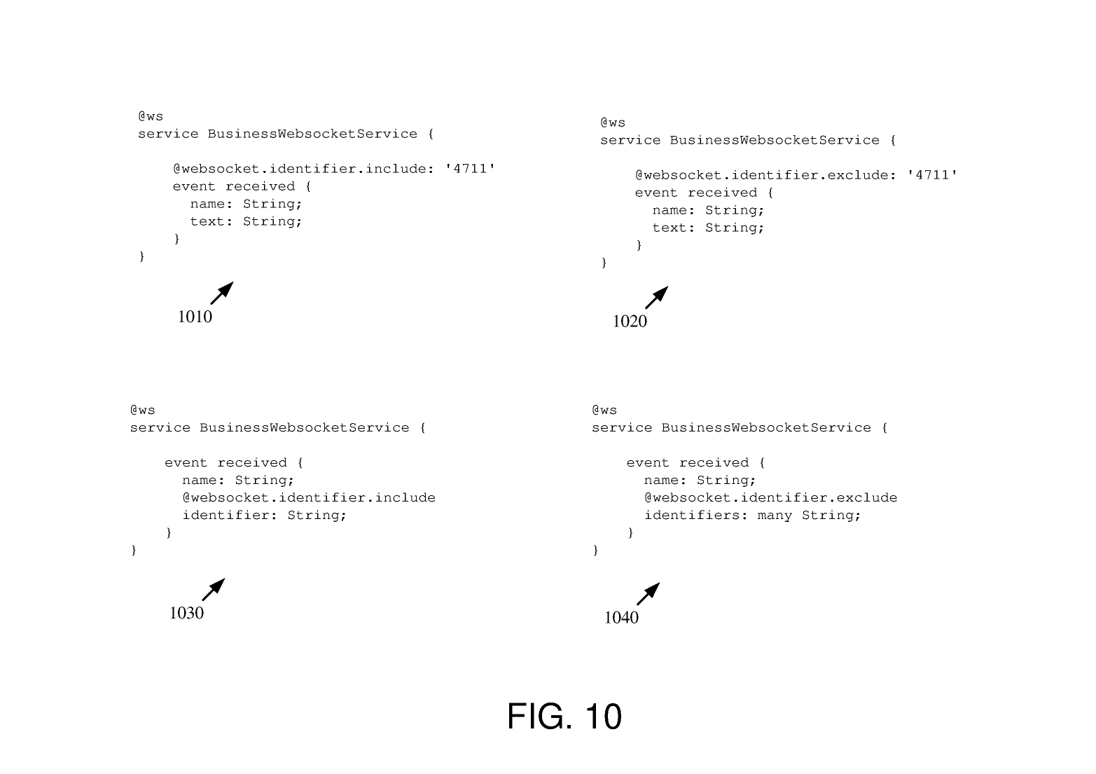

FIG. 10 applies client-specific filtering so that WebSocket messages are routed only to authorized client devices. In the depicted example, annotation 1010 statically includes a client identified by the identifier ‘4711’, while annotation 1020 excludes the client with the same identifier. Annotations 1030 and 1040 introduce dynamic filtering, where client inclusion/exclusion is determined at runtime using a single string identifier or a list of multiple client identifiers.

It should be understood that the examples shown in FIGS. 7-10 are non-exclusive, and there can be variants based on specific implementation needs. For instance, the identifier in annotation 1030 (dynamic client inclusion) could be defined as “many String”, allowing multiple identifiers to be specified at runtime, while annotation 1040 (dynamic client exclusion) could use “String”, applying a single client exclusion rule. Similar variations can be applied to other filters, such as using “many String” for dynamic user or topic filters to allow multiple users or topics to be specified at runtime, or configuring static filters to include lists of predefined values instead of single entries.

### Example Advantages

A number of advantages can be achieved via the technology described herein. Traditional WebSocket communication operates as a low-level protocol that lacks context awareness and is not suitable for enterprise-scale, multi-tenant computing environments requiring controlled, role-based, and event-driven message distribution. Implementing WebSockets in a multi-tenant system conventionally requires significant development effort to ensure proper tenant isolation, service-level segregation, and recipient-specific filtering, making it a complex and resource-intensive task.

The disclosed context-aware WebSocket communication technologies overcome these limitations by introducing a structured filtering mechanism including multi-layered filters for tenant isolation, service segmentation, user authentication, topic-based distribution, and client-specific targeting. This systematic approach ensures that WebSocket events are delivered only to authorized users and relevant client devices, reducing unnecessary message transmissions and optimizing network bandwidth utilization while maintaining strict access control and efficient event distribution.

Further, the technologies disclosed herein can enhance flexibility and adaptability of context-aware WebSocket communication by supporting both static and dynamic filters. Static filters provide predefined inclusion and exclusion rules, while dynamic filters enable recipient determination at runtime based on event metadata and payload content, allowing for more responsive and context-aware message distribution. By leveraging event-driven processing and rule-based filtering, the disclosed context-aware WebSocket communication framework ensures precise, real-time event routing, reducing unnecessary transmissions and enhancing security, scalability, and operational efficiency.

### Example Computing Systems

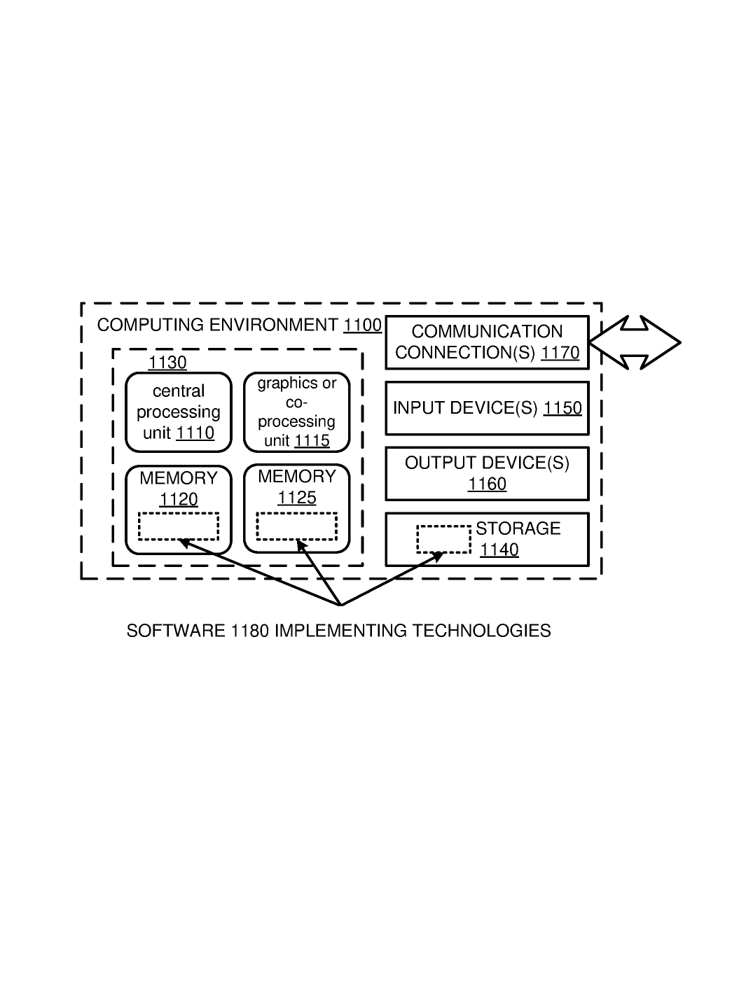

FIG. 11 depicts an example of a suitable computing system 1100 in which the described innovations can be implemented. The computing system 1100 is not intended to suggest any limitation as to scope of use or functionality of the present disclosure, as the innovations can be implemented in diverse computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 can execute computer-executable instructions, such as for implementing the features described in the examples herein (e.g., the method 300). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 11 shows a central processing unit 1110 as well as a graphics processing unit or co-processing unit 1115. The tangible memory 1120, 1125 can be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 can store software 1180 implementing one or more innovations described herein, in the form of computer-executable instructions suitable for execution by the processing unit(s) 1110, 1115.

A computing system 1100 can have additional features. For example, the computing system 1100 can include storage 1140, one or more input devices 1150, one or more output devices 1160, and one or more communication connections 1170, including input devices, output devices, and communication connections for interacting with a user. An interconnection mechanism (not shown) such as a bus, controller, or network can interconnect the components of the computing system 1100. Typically, operating system software (not shown) can provide an operating environment for other software executing in the computing system 1100, and coordinate activities of the components of the computing system 1100.

The tangible storage 1140 can be removable or non-removable, and includes magnetic disks, magnetic tapes or cassettes, CD-ROMs, DVDs, or any other medium which can be used to store information in a non-transitory way and which can be accessed within the computing system 1100. The storage 1140 can store instructions for the software implementing one or more innovations described herein.

The input device(s) 1150 can be an input device such as a keyboard, mouse, pen, or trackball, a voice input device, a scanning device, touch device (e.g., touchpad, display, or the like) or another device that provides input to the computing system 1100. The output device(s) 1160 can be a display, printer, speaker, CD-writer, or another device that provides output from the computing system 1100.

The communication connection(s) 1170 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

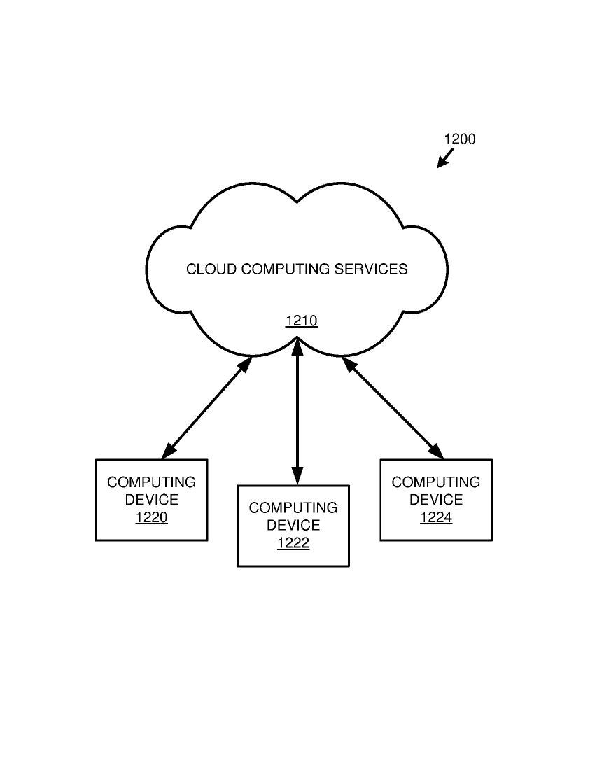

FIG. 12 depicts an example cloud computing environment 1200 in which the described technologies can be implemented, including, e.g., the system disclosed above and other systems herein. The cloud computing environment 1200 can include cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 can be utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operations (e.g., data processing, data storage, and the like).

In practice, cloud-based, on-premises-based, or hybrid scenarios can be supported.

### Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example Clauses

Any of the following clauses can be implemented.

Clause 1. A computer-implemented method for context-aware WebSocket communication, the computer-implemented method comprising: receiving an event published by an application running on a server in response to a request for a service, wherein the server hosts multiple tenants in a multi-tenant computing environment; and communicating the event to a group of target users using a WebSocket protocol based on context of the event, comprising: filtering a full list of users of the server, using a tenant filter, to identify a group of tenant users, wherein the group of tenant users belong to a tenant identified by the event; filtering the group of tenant users, using a service filter, to identify a group of service-specific users interacting with the service identified by the event; filtering the group of service-specific users, using one or more user filters, to identify a group of eligible users permitted to receive the event; filtering the group of eligible users, using one or more topic filters, to identify the group of target users who subscribe to a topic of the event; and routing the event, via WebSocket connections, to a group of target clients associated with the group of target users.

Clause 2. The computer-implemented method of clause 1, further comprising defining the one or more user filters and the one or more topic filters in a configuration file.

Clause 3. The computer-implemented method of any one of clauses 1-2, wherein communicating the event further comprises filtering a full list of clients associated with the group of target users, using one or more client filters, to identify the group of target clients receiving the event via the WebSocket connections, wherein at least one target user is associated with a plurality of clients, wherein the one or more client filters are configured to identify which clients, if any, among the plurality of clients, are target clients for receiving the event.

Clause 4. The computer-implemented method of clause 3, further comprising defining the one or more client filters in a configuration file, wherein the one or more client filters specify inclusion or exclusion of specific clients, among the full list of clients, to determine the group of target clients.

Clause 5. The computer-implemented method of clause 4, wherein the specific clients are determined from a payload of the event when the application generates the event at runtime.

Clause 6. The computer-implemented method of any one of clauses 2-5, wherein defining the one or more user filters comprises specifying inclusion or exclusion of specific users, among the group of service-specific users, to determine eligible users.

Clause 7. The computer-implemented method of clause 6, wherein the specific users comprise a current user who initiated the request for the service and one or more predefined users other than the current user.

Clause 8. The computer-implemented method of any one of clauses 6-7, wherein the specific users are determined from a payload of the event when the application generates the event at runtime.

Clause 9. The computer-implemented method of any one of clauses 2-8, wherein defining the one or more topic filters comprises specifying inclusion or exclusion of specific topics, among a plurality of topics, to determine whether an eligible user subscribed to the topic of the event is identified as a target user.

Clause 10. The computer-implemented method of clause 9, wherein the specific topics are determined from a payload of the event when the application generates the event at runtime.

Clause 11. A computing system comprising: memory; one or more hardware processors coupled to the memory; and one or more computer readable storage media storing instructions that, when loaded into the memory, cause the one or more hardware processors to perform operations comprising: receiving an event published by an application running on a server in response to a request for a service, wherein the server hosts multiple tenants in a multi-tenant computing environment; and communicating the event to a group of target users using a WebSocket protocol based on context of the event, comprising: filtering a full list of users of the server, using a tenant filter, to identify a group of tenant users, wherein the group of tenant users belong to a tenant identified by the event; filtering the group of tenant users, using a service filter, to identify a group of service-specific users interacting with the service identified by the event; filtering the group of service-specific users, using one or more user filters, to identify a group of eligible users permitted to receive the event; filtering the group of eligible users, using one or more topic filters, to identify the group of target users who subscribe to a topic of the event; and routing the event, via WebSocket connections, to a group of target clients associated with the group of target users.

Clause 12. The computing system of clause 11, wherein the one or more user filters and the one or more topic filters are defined in a configuration file.

Clause 13. The computing system of any one of clauses 11-12, wherein communicating the event further comprises filtering a full list of clients associated with the group of target users, using one or more client filters, to identify the group of target clients receiving the event via the WebSocket connections, wherein at least one target user is associated with a plurality of clients, wherein the one or more client filters are configured to identify which clients, if any, among the plurality of clients, are target clients for receiving the event.

Clause 14. The computing system of clause 13, wherein the one or more client filters are defined in a configuration file, and specify inclusion or exclusion of specific clients, among the full list of clients, to determine the group of target clients.

Clause 15. The computing system of clause 14, wherein the specific clients are determined from a payload of the event when the application generates the event at runtime.

Clause 16. The computing system of any one of clauses 11-15, wherein the one or more user filters specify inclusion or exclusion of specific users, among the group of service-specific users, to determine eligible users.

Clause 17. The computing system of clause 16, wherein the specific users are determined from a payload of the event when the application generates the event at runtime.

Clause 18. The computing system of any one of clauses 11-17, wherein the one or more topic filters specify inclusion or exclusion of specific topics, among a plurality of topics, to determine whether an eligible user subscribed to the topic of the event is identified as a target user.

Clause 19. The computing system of clause 18, wherein the specific topics are determined from a payload of the event when the application generates the event at runtime.

Clause 20. One or more non-transitory computer-readable media having encoded thereon computer-executable instructions causing one or more processors to perform a method comprising: receiving an event published by an application running on a server in response to a request for a service, wherein the server hosts multiple tenants in a multi-tenant computing environment; and communicating the event to a group of target users using a WebSocket protocol based on context of the event, comprising: filtering a full list of users of the server, using a tenant filter, to identify a group of tenant users, wherein the group of tenant users belong to a tenant identified by the event; filtering the group of tenant users, using a service filter, to identify a group of service-specific users interacting with the service identified by the event; filtering the group of service-specific users, using one or more user filters, to identify a group of eligible users permitted to receive the event; filtering the group of eligible users, using one or more topic filters, to identify the group of target users who subscribe to a topic of the event; and routing the event, via WebSocket connections, to a group of target clients associated with the group of target users.

The technologies from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

### Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method for context-aware WebSocket communication, the computer-implemented method comprising:
receiving an event published by an application running on a server in response to a request for a service, wherein the server hosts multiple tenants in a multi-tenant computing environment; and
communicating the event to a group of target users using a WebSocket protocol based on context of the event, comprising:
filtering a full list of users of the server, using a tenant filter, to identify a group of tenant users, wherein the group of tenant users belong to a tenant identified by the event;
filtering the group of tenant users, using a service filter, to identify a group of service-specific users interacting with the service identified by the event;
filtering the group of service-specific users, using one or more user filters, to identify a group of eligible users permitted to receive the event;
filtering the group of eligible users, using one or more topic filters, to identify the group of target users who subscribe to a topic of the event; and
routing the event, via WebSocket connections, to a group of target clients associated with the group of target users.

2. The computer-implemented method of claim 1, further comprising defining the one or more user filters and the one or more topic filters in a configuration file.

3. The computer-implemented method of claim 1, wherein communicating the event further comprises filtering a full list of clients associated with the group of target users, using one or more client filters, to identify the group of target clients receiving the event via the WebSocket connections, wherein at least one target user is associated with a plurality of clients, wherein the one or more client filters are configured to identify which clients, if any, among the plurality of clients, are target clients for receiving the event.

4. The computer-implemented method of claim 3, further comprising defining the one or more client filters in a configuration file, wherein the one or more client filters specify inclusion or exclusion of specific clients, among the full list of clients, to determine the group of target clients.

5. The computer-implemented method of claim 4, wherein the specific clients are determined from a payload of the event when the application generates the event at runtime.

6. The computer-implemented method of claim 2, wherein defining the one or more user filters comprises specifying inclusion or exclusion of specific users, among the group of service-specific users, to determine eligible users.

7. The computer-implemented method of claim 6, wherein the specific users comprise a current user who initiated the request for the service and one or more predefined users other than the current user.

8. The computer-implemented method of claim 6, wherein the specific users are determined from a payload of the event when the application generates the event at runtime.

9. The computer-implemented method of claim 2, wherein defining the one or more topic filters comprises specifying inclusion or exclusion of specific topics, among a plurality of topics, to determine whether an eligible user subscribed to the topic of the event is identified as a target user.

10. The computer-implemented method of claim 9, wherein the specific topics are determined from a payload of the event when the application generates the event at runtime.

11. A computing system comprising:
memory;
one or more hardware processors coupled to the memory; and
one or more computer readable storage media storing instructions that, when loaded into the memory, cause the one or more hardware processors to perform operations comprising:
receiving an event published by an application running on a server in response to a request for a service, wherein the server hosts multiple tenants in a multi-tenant computing environment; and
communicating the event to a group of target users using a WebSocket protocol based on context of the event, comprising:
filtering a full list of users of the server, using a tenant filter, to identify a group of tenant users, wherein the group of tenant users belong to a tenant identified by the event;
filtering the group of tenant users, using a service filter, to identify a group of service-specific users interacting with the service identified by the event;
filtering the group of service-specific users, using one or more user filters, to identify a group of eligible users permitted to receive the event;
filtering the group of eligible users, using one or more topic filters, to identify the group of target users who subscribe to a topic of the event; and
routing the event, via WebSocket connections, to a group of target clients associated with the group of target users.

12. The computing system of claim 11, wherein the one or more user filters and the one or more topic filters are defined in a configuration file.

13. The computing system of claim 11, wherein communicating the event further comprises filtering a full list of clients associated with the group of target users, using one or more client filters, to identify the group of target clients receiving the event via the WebSocket connections, wherein at least one target user is associated with a plurality of clients, wherein the one or more client filters are configured to identify which clients, if any, among the plurality of clients, are target clients for receiving the event.

14. The computing system of claim 13, wherein the one or more client filters are defined in a configuration file, and specify inclusion or exclusion of specific clients, among the full list of clients, to determine the group of target clients.

15. The computing system of claim 14, wherein the specific clients are determined from a payload of the event when the application generates the event at runtime.

16. The computing system of claim 11, wherein the one or more user filters specify inclusion or exclusion of specific users, among the group of service-specific users, to determine eligible users.

17. The computing system of claim 16, wherein the specific users are determined from a payload of the event when the application generates the event at runtime.

18. The computing system of claim 11, wherein the one or more topic filters specify inclusion or exclusion of specific topics, among a plurality of topics, to determine whether an eligible user subscribed to the topic of the event is identified as a target user.

19. The computing system of claim 18, wherein the specific topics are determined from a payload of the event when the application generates the event at runtime.

20. One or more non-transitory computer-readable media having encoded thereon computer-executable instructions causing one or more processors to perform a method comprising:
receiving an event published by an application running on a server in response to a request for a service, wherein the server hosts multiple tenants in a multi-tenant computing environment; and
communicating the event to a group of target users using a WebSocket protocol based on context of the event, comprising:
filtering a full list of users of the server, using a tenant filter, to identify a group of tenant users, wherein the group of tenant users belong to a tenant identified by the event;
filtering the group of tenant users, using a service filter, to identify a group of service-specific users interacting with the service identified by the event;
filtering the group of service-specific users, using one or more user filters, to identify a group of eligible users permitted to receive the event;
filtering the group of eligible users, using one or more topic filters, to identify the group of target users who subscribe to a topic of the event; and
routing the event, via WebSocket connections, to a group of target clients associated with the group of target users.
